(19) United States
(12) Patent Application Publication
(10) Pub. No.: US 2026/0112546 A1
(43) Pub. Date: Apr. 23, 2026

(54) SOLID ELECTROLYTIC CAPACITOR

(71) Applicant: TDK CORPORATION, Tokyo (JP)

(72) Inventors: Hideyuki KOBAYASHI, Tokyo (JP); Takaaki Morita, Tokyo (JP); Tetsushi Inoue, Tokyo (JP)

(73) Assignee: TDK CORPORATION, Tokyo (JP)

(21) Appl. No.: 19/360,178

(22) Filed: Oct. 16, 2025

(30) Foreign Application Priority Data
Oct. 18, 2024 (JP) 2024-184475

(51) Int. Cl. H01G 9/08; H01G 9/00; H01G 9/012; H01G 9/042; H01G 9/048; H01G 9/15

(52) U.S. Cl. CPC H01G 9/08; H01G 9/0029; H01G 9/012; H01G 9/0425; H01G 9/048; H01G 9/15

(57) ABSTRACT

The solid electrolytic capacitor includes first and second solid electrolyte layers; an anode electrode layer; an upper cathode electrode layer and a lower cathode electrode layer; a first side electrode in contact with the anode's first side surface; a second side electrode in contact with side surfaces of the upper and lower cathode layers; a resin insulating portion between the anode's second side surface and the second side electrode; a first insulating layer between the upper cathode layer and the insulating portion; and a second insulating layer between the lower cathode layer and the insulating portion. The filler contents and the like in the first insulating layer, the second insulating layer, and the insulating portion are set.

### CROSS-REFERENCE TO RELATED APPLICATIONS

This application claims the benefit of priority to Japanese Patent Application No. 2024-184475, filed on Oct. 18, 2024. The entire contents of the above-identified application are hereby incorporated by reference.

### TECHNICAL FIELD

The present disclosure relates to a solid electrolytic capacitor.

### BACKGROUND

International Publication No. 2019/087692 discloses a solid electrolytic capacitor.

### SUMMARY

A solid electrolytic capacitor with high resistance to environmental changes is desired.

A first solid electrolytic capacitor of the present disclosure comprises: a first solid electrolyte layer disposed between an anode electrode layer and a first cathode electrode layer; a second solid electrolyte layer disposed between the anode electrode layer and a second cathode electrode layer; a first side electrode in contact with a first side surface of the anode electrode layer; a second side electrode in contact with a side surface of the first cathode electrode layer and a side surface of the second cathode electrode layer; an insulating portion disposed between a second side surface of the anode electrode layer and the second side electrode, the insulating portion including a resin; a first insulating layer disposed between the first cathode electrode layer and the insulating portion and including a resin and a filler; and a second insulating layer disposed between the second cathode electrode layer and the insulating portion and including a resin and a filler, wherein a filler content C_{Z1} (mass %) of the first insulating layer, a filler content C_{Z2} (mass %) of the second insulating layer, and a filler content C_{M0} (mass %) of the insulating portion satisfy C_{M0}<C_{Z1} and C_{M0}<C_{Z2}.

A second solid electrolytic capacitor of the present disclosure comprises: a first solid electrolyte layer disposed between an anode electrode layer and a first cathode electrode layer; a second solid electrolyte layer disposed between the anode electrode layer and a second cathode electrode layer; a first side electrode in contact with a first side surface of the anode electrode layer; a second side electrode in contact with a side surface of the first cathode electrode layer and a side surface of the second cathode electrode layer; an insulating portion disposed between a second side surface of the anode electrode layer and the second side electrode and including a resin; a first insulating layer disposed between the first cathode electrode layer and the insulating portion and including a resin and a filler; and a second insulating layer disposed between the second cathode electrode layer and the insulating portion and including a resin and a filler, wherein the insulating portion comprises: a first resin layer located on a side of the first insulating layer; a second resin layer located on a side of the second insulating layer; and an intermediate resin layer disposed between the first resin layer and the second resin layer and having a filler content higher than that of each of the first resin layer and the second resin layer, and wherein a filler content C_{Z1} (mass %) of the first insulating layer, a filler content C_{Z2} (mass %) of the second insulating layer, a filler content C_{M1} (mass %) of the first resin layer, a filler content C_{M2} (mass %) of the second resin layer, and a filler content C_{A1} (mass %) of the intermediate resin layer satisfy C_{M1}<C_{Z1}, C_{M2}<C_{Z2}, C_{M1}<C_{A1}, and C_{M2}<C_{A1}.

According to the solid electrolytic capacitor of the present disclosure, resistance to environmental changes is enhanced.

### BRIEF DESCRIPTION OF THE DRAWINGS

FIG. 1 is a diagram illustrating a longitudinal cross-sectional configuration of a solid electrolytic capacitor.

FIG. 2 is a diagram illustrating a longitudinal cross-sectional configuration of a solid electrolytic capacitor element.

FIG. 3 is an enlarged view of a vicinity region of a second side electrode in a solid electrolytic capacitor element (first example).

FIG. 4 is an enlarged view of a vicinity region of a second side electrode in a solid electrolytic capacitor element (second example).

FIG. 5A is a schematic diagram illustrating a vicinity region of a second side electrode of a solid electrolytic capacitor element according to a first example, FIG. 5B is a schematic diagram illustrating a vicinity region of a second side electrode of a solid electrolytic capacitor element according to a second example, and FIG. 5C is a schematic diagram illustrating a vicinity region of a second side electrode of a solid electrolytic capacitor element according to a comparative example.

FIG. 6 is a chart illustrating parameters and evaluation results of each element in the first example.

FIG. 7 is a chart illustrating parameters and evaluation results of each element in the second example.

FIG. 8 is a chart illustrating parameters and evaluation results of each element in the second example.

### DETAILED DESCRIPTION

Hereinafter, various exemplary embodiments will be described in detail with reference to the drawings. In the drawings, identical or corresponding parts are denoted by the same reference numerals, and redundant descriptions will be omitted.

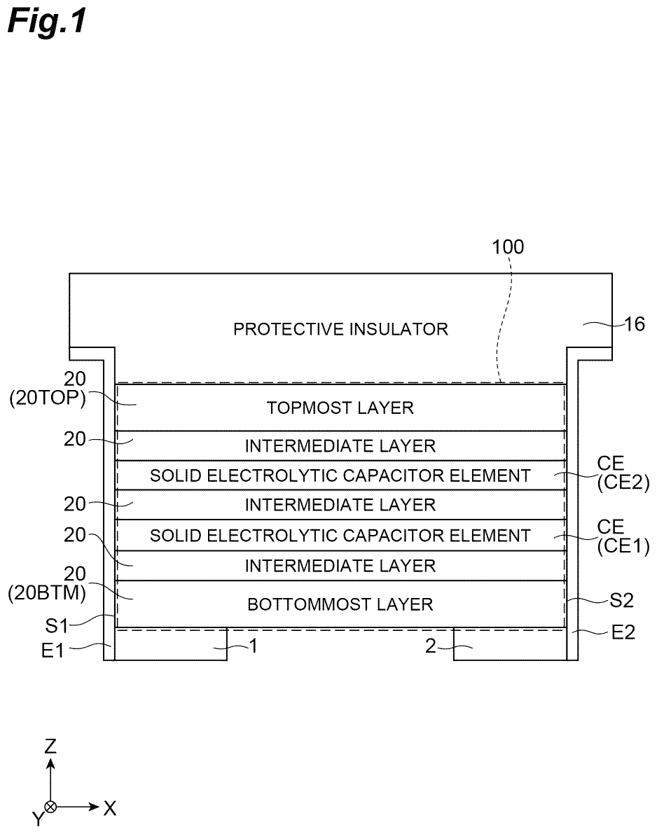

FIG. 1 is a diagram illustrating a longitudinal cross-sectional configuration of a solid electrolytic capacitor.

The solid electrolytic capacitor includes a bottommost layer 20BTM as a support substrate, a laminate 100 including the support substrate, and a protective insulator 16 provided on a top surface and side surfaces of the laminate 100 where no electrodes are formed. An anode terminal 1 and a cathode terminal 2 are provided on a lower surface of the support substrate. A first side electrode E1 electrically connected to the anode terminal 1 is provided on a first side surface S1 of the laminate 100. A second side electrode E2 electrically connected to the cathode terminal 2 is provided on a second side surface S2 of the laminate 100.

A three-dimensional orthogonal coordinate system is set. A stacking direction of solid electrolytic capacitor elements CE in the laminate 100 is the Z-axis direction. The X-axis is perpendicular to the Z-axis and extends in a direction from the first side electrode E1 toward the second side electrode E2. The Y-axis is perpendicular to the Z-axis and is also perpendicular to the X-axis. The first side surface S1 is one YZ plane of the laminate 100, and the second side surface S2 is the other YZ plane of the laminate 100.

The laminate 100 includes a plurality of solid electrolytic capacitor elements CE and a plurality of insulating layers (20). The plurality of insulating layers (20) includes the bottommost layer 20BTM (20), a topmost layer 20TOP (20), and one or more intermediate layers 20.

The bottommost layer 20BTM (20) constitutes the support substrate. The topmost layer 20TOP is disposed between the protective insulator 16 and an upper solid electrolytic capacitor element CE. The plurality of intermediate layers 20 includes an intermediate layer 20 disposed between the bottommost layer 20BTM and a lower solid electrolytic capacitor element, an intermediate layer 20 disposed between solid electrolytic capacitor elements CE adjacent in a thickness direction, and an intermediate layer 20 disposed between the topmost layer 20TOP and the upper solid electrolytic capacitor element CE.

The bottommost layer 20BTM increases the mechanical strength of the solid electrolytic capacitor and also functions as a barrier to protect internal layers from external contaminants. The topmost layer 20TOP increases the mechanical strength of the solid electrolytic capacitor and also functions as a barrier, together with the protective insulator 16, to protect internal layers from external contaminants. By providing the solid electrolytic capacitor with the bottommost layer 20BTM and the topmost layer 20TOP, stress generated inside the laminate due to environmental changes can be suppressed. Furthermore, by providing the solid electrolytic capacitor with one or more intermediate layers 20, stress generated inside the laminate due to environmental changes can be further suppressed.

In the figure, two solid electrolytic capacitor elements CE (a first solid electrolytic capacitor element CE1 and a second solid electrolytic capacitor element CE2) are shown. The number of solid electrolytic capacitor elements CE can be two or more, for example, four or five. Even when the number of solid electrolytic capacitor elements CE increases, an intermediate layer 20 is disposed between the solid electrolytic capacitor elements CE adjacent in the thickness direction.

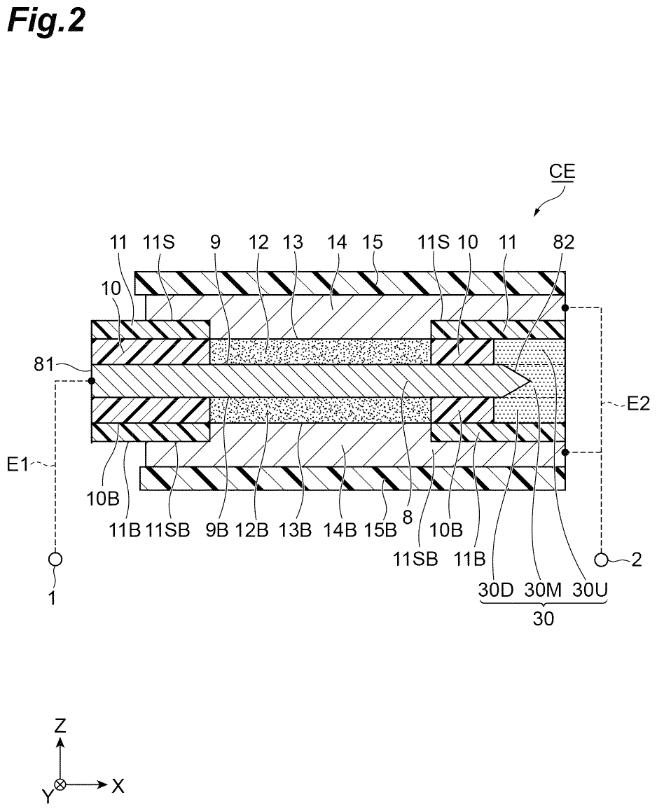

FIG. 2 is a diagram illustrating a longitudinal cross-sectional configuration of a solid electrolytic capacitor element CE.

One solid electrolytic capacitor element CE includes an anode electrode layer 8.

The solid electrolytic capacitor element CE includes, in an upper region of the anode electrode layer 8, an upper cathode electrode layer 14 and a solid electrolyte layer 12 disposed between the anode electrode layer 8 and the upper cathode electrode layer 14 (first cathode electrode layer). The solid electrolyte layer 12 is composed of a roughened layer including a conductive polymer. In an interface vicinity region between the anode electrode layer 8 and the solid electrolyte layer 12, a dielectric layer 9 is formed along an irregular topography inside the roughened layer of the solid electrolyte layer 12. On an upper surface of the solid electrolyte layer 12, a residual conductive polymer layer that did not infiltrate the inside of the roughened layer during addition to the roughened layer may be formed, and a first conductive layer 13 is formed in contact with the conductive polymer layer. The first conductive layer 13 can be formed not only on the upper surface of the solid electrolyte layer 12 but also on an upper surface 11S of a pair of first insulating layers 11 formed at both ends in the X-axis direction of the solid electrolytic capacitor element CE. On an upper surface of the first conductive layer 13, the upper cathode electrode layer 14 is formed. On an upper surface of the upper cathode electrode layer 14, a first protective layer 15 is formed.

In the upper region of the anode electrode layer 8, upper insulating regions 10 are formed as a pair of mixed regions in the vicinity of both ends in the X-axis direction. One upper insulating region 10 is located in the vicinity of the first side electrode E1. The other upper insulating region 10 is located in the vicinity of the second side electrode E2. On an upper surface of each upper insulating region 10, the first insulating layer 11 is formed. On the upper surface of the first insulating layer 11, the upper cathode electrode layer 14 is formed. The material of the pair of upper insulating regions 10 includes a first metal and a first resin. The first metal is aluminum constituting the roughened layer, and the first resin is a thermosetting resin such as an epoxy resin.

The solid electrolytic capacitor element CE includes, in a lower region of the anode electrode layer 8, a lower cathode electrode layer 14B (second cathode electrode layer) and a second solid electrolyte layer 12B disposed between the anode electrode layer 8 and the lower cathode electrode layer 14B. The second solid electrolyte layer 12B is composed of a roughened layer including a conductive polymer. In an interface vicinity region between the anode electrode layer 8 and the second solid electrolyte layer 12B, a second dielectric layer 9B is formed along an irregular topography inside the roughened layer of the second solid electrolyte layer 12B. On a lower surface of the second solid electrolyte layer 12B, a residual conductive polymer layer that did not infiltrate the inside of the roughened layer during addition to the roughened layer may be formed, and a second conductive layer 13B is formed in contact with the conductive polymer layer. The second conductive layer 13B can be formed not only on the lower surface of the solid electrolyte layer 12B but also on a lower second surface 11SB of a pair of second insulating layers 11B formed at both ends in the X-axis direction of the solid electrolytic capacitor element CE. On a lower surface of the second conductive layer 13B, the lower cathode electrode layer 14B is formed. On a lower surface of the lower cathode electrode layer 14B, a second protective layer 15B is formed.

In the lower region of the anode electrode layer 8, a pair of lower insulating regions 10B are formed as mixed regions in the vicinity of both ends in the X-axis direction. One lower insulating region 10B is located in the vicinity of the first side electrode E1. The other lower insulating region 10B is located in the vicinity of the second side electrode E2. On a lower surface of each lower insulating region 10B, a second insulating layer 11B is formed. On the lower surface of the second insulating layer 11B, the lower cathode electrode layer 14B is formed. The material of the pair of lower insulating regions 10B includes the above-described first metal (roughened layer made of aluminum) and first resin (thermosetting resin such as epoxy resin).

The first side electrode E1 is in contact with one side surface of the anode electrode layer 8 and is electrically connected to the anode terminal 1. The first side electrode E1 is not in contact with one side surface of the upper cathode electrode layer 14. The second side electrode E2 is in contact with the other side surface of the upper cathode electrode layer 14 and is electrically connected to the cathode terminal 2. The second side electrode E2 is not in contact with the other side surface of the anode electrode layer 8, and an insulating portion 30 is interposed between the second side electrode E2 and the anode electrode layer 8.

The material of the insulating portion 30 includes the same material as the material of the protective insulator 16, and preferably includes a filler in a resin (e.g., epoxy resin). In a first example, the insulating portion 30 is composed of a single layer, and in a second example, the insulating portion 30 has a three-layer structure of an upper layer 30U, a middle layer 30M, and a lower layer 30D. In the case of the first example, the three-layer structure of the insulating portion 30 in FIG. 2 becomes a single-layer structure.

An example of the material of the anode electrode layer 8 is aluminum. An example of the material of the roughened layers formed on the upper and lower surfaces of the anode electrode layer 8 is aluminum. An example of the material of the dielectric layer 9 formed in the vicinity of the surface of the anode electrode layer 8 is aluminum oxide (Al₂O₃). An example of the material of the solid electrolyte layer 12 is one in which a roughened layer of aluminum is impregnated with a conductive polymer. An example of the material of the upper cathode electrode layer 14 is copper. The material of each element on the lower side of the anode electrode layer 8 is the same as the material of the corresponding element on the upper side.

The mixed regions (insulating regions (10, 10B)) on the first side electrode side and the second side electrode side include a first metal (such as aluminum) and a first resin (a thermosetting resin such as epoxy resin). The insulating layers (11, 11B) on the first side electrode side and the second side electrode side include a filler such as silica and a resin (a thermosetting resin such as epoxy resin).

The first side electrode E1 is in contact with a first side surface 81 of the anode electrode layer 8. The second side electrode E2 is in contact with a second side surface 82 of the anode electrode layer 8. The second side electrode E2 is in contact with and electrically connected to the upper cathode electrode layer 14 and the lower cathode electrode layer 14B, but the mechanical resistance of this connection portion depends on the stress generated in the vicinity region of the second side electrode E2.

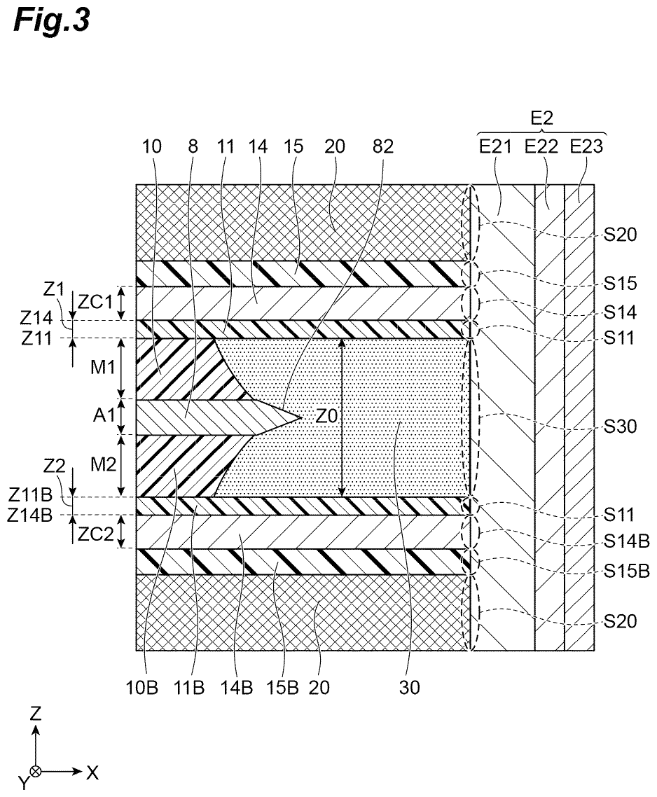

FIG. 3 is an enlarged view of a vicinity region of a second side electrode in a solid electrolytic capacitor element (first example).

The insulating portion 30 is interposed between the second side surface 82 of the anode electrode layer 8 and the second side electrode E2. The insulating portion 30 includes a resin and can further include a filler. The second side surface 82 protrudes toward the second side electrode E2, and in an XZ cross-section, a tip portion constituting the second side surface 82 is pointed so as to have two sides forming an acute angle. A laminated structure along the Z-axis passing through the insulating portion 30 includes, in order from the top, the upper cathode electrode layer 14, the first insulating layer 11, the insulating portion 30, the second insulating layer 11B, and the lower cathode electrode layer 14B.

The first insulating layer 11 is disposed directly below the upper cathode electrode layer 14. In other words, the first insulating layer 11 is interposed between the upper cathode electrode layer 14 and the insulating portion 30. The second insulating layer 11B is disposed directly above the lower cathode electrode layer 14B. In other words, the second insulating layer 11B is interposed between the lower cathode electrode layer 14B and the insulating portion 30. In the solid electrolytic capacitor of this example, the adhesion strength at the interfaces between the upper cathode electrode layer 14 and the second side electrode E2, and between the lower cathode electrode layer 14B and the second side electrode E2, is increased, whereas the adhesion strength in regions other than these bonding interfaces is selectively reduced to a relatively lower level.

When an environmental change such as a change in temperature (humidity) occurs and stress is generated internally, the portion with relatively low adhesion strength delaminates due to the internal stress, and the connection portion of the cathode electrode layer can be protected from the influence of the internal stress. Therefore, the solid electrolytic capacitor having this structure has increased resistance to environmental changes.

In the solid electrolytic capacitor of this example, a prepreg in which resin and glass cloth are mixed can be used for the insulating layers constituting the intermediate layer 20, the topmost layer 20TOP, and the bottommost layer 20BTM in the laminate in FIG. 1. These layers can also have a structure that does not include glass cloth.

The solid electrolytic capacitor element and the second side electrode E2 are connected at a plurality of positions along the Z-axis direction. A first connection portion S14 is a portion where a side surface of the upper cathode electrode layer 14 and the second side electrode E2 are in contact and electrically connected. A second connection portion S14B is a portion where a side surface of the lower cathode electrode layer 14B and the second side electrode E2 are in contact and electrically connected. In the first example, the insulating portion 30 is made of, for example, only a resin (e.g., epoxy resin) that does not include a filler. A connection portion S30 between the insulating portion 30 and the second side electrode E2 is set to have a smaller adhesion strength than the vicinity of the cathode electrode layer, and when the temperature (humidity) is increased, the connection portion S30 breaks and enters a disconnected state before the cathode electrode layer becomes disconnected. Even in such a case, the solid electrolytic capacitor can operate, so the resistance to environmental changes is enhanced.

At each of these connection portions, the strength at which joined or adhered elements do not physically separate is defined as adhesion strength. In other words, when a solid electrolytic capacitor is heated, stress that causes each element to expand in the thickness direction and in-plane direction is applied, and the greater the magnitude of the stress when the connected elements physically separate, the higher the adhesion strength is considered to be. Although there are shear strength, peel strength, and tensile strength at each connection portion, here, the strength that suppresses the resulting disconnected state is expressed as adhesion strength. The expression “connection strength” may be used instead of adhesion strength.

In the solid electrolytic capacitor of this example, the following adhesion strength can be further set to increase the resistance to environmental changes.

An upper intermediate layer connection portion S20 in FIG. 3 is a portion where a side surface of an upper intermediate layer 20 and the second side electrode E2 are in contact, adhered, and connected. An upper first protective layer connection portion S15 is a portion where a side surface of an upper first protective layer 15 and the second side electrode E2 are in contact, adhered, and connected. An upper first insulating layer connection portion S11 is a portion where a side surface of an upper first insulating layer 11 and the second side electrode E2 are in contact, adhered, and connected.

Similarly, a lower intermediate layer connection portion S20 in FIG. 3 is a portion where a side surface of a lower intermediate layer 20 and the second side electrode E2 are in contact, adhered, and connected. A lower second protective layer connection portion S15B is a portion where a side surface of a lower second protective layer 15B and the second side electrode E2 are in contact, adhered, and connected. A lower second insulating layer connection portion S11B is a portion where a side surface of a lower second insulating layer 11B and the second side electrode E2 are in contact, adhered, and connected.

In order to increase the adhesion strength in the vicinity of the connection portions of the upper cathode electrode layer 14 and the lower cathode electrode layer 14B, the layers adjacent to the respective cathode electrode layers (the first insulating layer 11, the first protective layer 15, the upper intermediate layer 20, the second insulating layer 11B, the second protective layer 15B, the lower intermediate layer 20) contain a resin and a filler, thereby increasing the adhesion strength at the respective connection portions. Further, the adhesion strength of these connection portions can be set higher than the adhesion strength in the insulating portion 30.

The first insulating layer 11 and the second insulating layer 11B each include a resin and a filler, and enhance the adhesion strength in the vicinity of the cathode electrode layer.

As a result of the above, by sacrificing the destruction in the insulating portion 30, the disconnection of the connection portion in the vicinity of the cathode electrode layer can be suppressed.

Next, the detailed materials and structures of each element will be further described.

The second side electrode E2 is made of a conductive material. The second side electrode E2 of this example includes a first electrode layer E21, a second electrode layer E22, and a third electrode layer E23, but may have a single-layer structure.

The first electrode layer E21 is made of a material with excellent electrical conductivity. A preferred example of the thickness of the first electrode layer E21 is 5 μm or more and 15 μm or less, and a more preferred example of the thickness is 8 μm or more and 12 μm or less. As the first electrode layer E21, a plating layer including a material with excellent conductivity, that is, copper (Cu) or silver (Ag), can be preferably used.

The second electrode layer E22 is an intermediate layer interposed between the first electrode layer E21 and the third electrode layer E23. The second electrode layer E22 has a role of preventing diffusion of Sn or the like contained in solder or the third electrode layer, and preventing oxidation of Cu or the like contained in the first electrode layer. As the material of the second electrode layer E22, Ni or the like, which is more resistant to oxidation than Cu and inhibits metal diffusion, can be used. If the second electrode layer E22 is too thin, its oxidation and diffusion prevention effects are weakened, and if it is too thick, the resistance value increases. A preferred example of the thickness of the second electrode layer E22 is 1 μm or more and 5 μm or less, and a more preferred example of the thickness is 2 μm or more and 4 μm or less. When the thickness is equal to or greater than the lower limit, the above-described diffusion prevention effect is obtained, and when the thickness is equal to or less than the upper limit, an increase in the resistance value can be suppressed. Illustratively, this thickness is 3 μm. Preferably, nickel (Ni), which is a more stable material than copper (Cu), can be used as the second electrode layer E22.

The third electrode layer E23 is made of a conductive material that makes good contact with an Sn alloy (solder) provided externally. As Sn alloys, Sn—Ag—Cu, Sn—Cu, Sn—Sb, Sn—Bi, and the like are known. The third electrode layer E23 can be composed of a metal (for example, an alloy such as Sn or SnAg) that has good wettability with a solder material. A preferred example of the thickness of the third electrode layer E23 is 3 μm or more and 7 μm or less, and a more preferred example of the thickness is 4 μm or more and 6 μm or less. When the thickness is equal to or greater than the lower limit, the influence of the underlying layer can be suppressed, and when the thickness is equal to or less than the upper limit, the material cost can be reduced. The third electrode layer E23 may be composed of a material (e.g., Au) including gold (Au), which has excellent conductivity and good wettability with solder. When gold is used, the effect can be obtained even if the thickness of the electrode layer is greater than 0 μm and 1μm or less, and when the thickness is greater than 0 μm and 0.1 μm or less, the effect can be obtained while reducing the cost.

The structure and material of the first side electrode E1 can be the same as the structure and material of the second side electrode E2. The structure and material of the first side electrode E1 and the structure and material of the second side electrode E2 can also be different.

The upper cathode electrode layer 14 and the lower cathode electrode layer 14B can each include at least one conductive material selected from the group consisting of copper, nickel, chromium, and silver. The first side electrode E1 and the second side electrode E2 can each include at least one conductive material (metal) selected from the group consisting of copper, nickel, tin, silver, gold, platinum, palladium, indium, bismuth, and antimony.

An interface between the anode electrode layer 8 and the upper insulating region 10 or the lower insulating region 10B is not a completely flat surface but has a fine irregular topography. The anode electrode layer 8 is not a roughened layer but is made of bulk metal. A thickness A1 along the Z-axis direction of the anode electrode layer 8 can be defined by a distance between an upper position ZU of an upper surface (interface) of the anode electrode layer 8 and a lower position ZD of a lower surface (interface). The upper position ZU is a Z-axis direction position of a plane that fits a point group constituting the upper surface (interface) of the anode electrode layer 8, and can be obtained by a least squares method that minimizes a distance between the point group and the plane. The lower position ZD is a Z-axis direction position of a plane that fits a point group constituting the lower surface (interface) of the anode electrode layer 8, and can be obtained by a least squares method that minimizes a distance between the point group and the plane. In other words, an average height position of the upper irregular topography can be defined as the upper position ZU, an average height position of the lower irregular topography can be defined as the lower position ZD, and a distance between them can be defined as the thickness A1 of the anode electrode layer 8.

A structure above the anode electrode layer 8 and a structure below it are basically mirror-symmetric with respect to the anode electrode layer 8 and are the same. A thickness of the upper insulating region 10 can be M1, and a thickness of the lower insulating region 10B can be M2. M1 is defined by a distance between a position Z11 of an interface between the upper insulating region 10 and the first insulating layer 11 and the upper position ZU of an interface between the upper insulating region 10 and the anode electrode layer 8. M2 is defined by a distance between a position Z11B of an interface between the lower insulating region 10B and the second insulating layer 11B and the lower position ZD of an interface between the lower insulating region 10B and the anode electrode layer 8. In this example, excluding an error component, M1=M2 is satisfied. Further, a thickness of the first insulating layer 11 is Z1, and a thickness of the second insulating layer 11B is Z2. Z1 is defined by a distance between a position Z14 of an interface between the first insulating layer 11 and the upper cathode electrode layer 14 and the position Z11. Z2 is defined by a distance between a position Z14B of an interface between the second insulating layer 11B and the lower cathode electrode layer 14B and the position Z11B.

When the filler content is high and the thickness is large, the adhesion strength at the connection portion can be increased, so when the above relationship is satisfied, the adhesion strength of the connection portion in the vicinity of the cathode electrode layer becomes relatively high, and the disconnection of the connection portion can be further suppressed.

It is preferable that A1, M1, and M2 have the following relationship.

A1 can be set to 1 μm≤A1≤300 μm. Preferably, A1 can be set to 10 μm≤A1≤110 μm. M1 can be set to 1 μm≤M1≤100 μm. Preferably, M1 can be set to 20 μm≤M1≤60 μm. M2 can be set to 1 μm≤M2≤100 μm. Preferably, M2 can be set to 20 μm≤M2≤60 μm.

When an environmental test of the solid electrolytic capacitor was conducted, it was confirmed that the resistance of the connection portion of the cathode electrode layer in a bias test under a high humidity environment was enhanced.

The materials and the like of each element constituting the solid electrolytic capacitor will be further described.

The number of solid electrolytic capacitor elements CE illustrated in FIG. 1 is assumed to be four. The thickness of each element in the laminate 100 is the dimension of each element in the stacking direction (Z-axis direction). The intermediate layer 20, the topmost layer 20TOP, and the bottommost layer 20BTM each includes a thermosetting resin such as an epoxy resin, and may be formed from prepregs that further include glass cloth. The glass cloth can be a plain weave glass cloth, and fibers constituting the glass cloth extend along the X-axis direction and the Y-axis direction.

The protective insulator 16 is made of an insulating material. As the insulating material, inorganic insulating materials and organic insulating materials are known.

As the inorganic insulating material, silicon oxide (e.g., SiO₂), silicon nitride (e.g., SiNx), aluminum oxide (e.g., Al₂O₃), magnesium oxide (e.g., MgO), and the like are known. As the organic insulating material, a thermosetting resin such as polyimide or epoxy resin is known. As a suitable insulating material for the protective insulator 16, an epoxy resin containing a filler is used in this example. Prior to thermosetting during manufacture, the protective insulator 16 may be in powder, liquid, granulated, or film form.

The bottommost layer 20BTM can constitute a support substrate. The structure of the bottommost layer 20BTM may be the same as the structure of the topmost layer 20TOP, but can also be a different structure. The bottommost layer 20BTM is made of an insulating material. As the insulating material, the above-described inorganic insulating materials and organic insulating materials are known. As an insulating material substrate including an inorganic insulating material, a glass substrate or an LTCC (low-temperature co-fired ceramics) substrate including alumina and a glass material is known. As an insulating material substrate including an organic insulating material, a glass-epoxy substrate such as FR4 (Flame Retardant type 4) in which glass fiber (glass cloth or glass nonwoven fabric) is impregnated with an epoxy resin and cured can also be used. As a suitable insulating material for the bottommost layer 20BTM, a glass-epoxy substrate is used in this example.

The anode terminal 1, the cathode terminal 2, the first side electrode E1, and the second side electrode E2 are composed of a metal material. An exemplary metal material is copper (Cu). A material (Sn) contained in solder may be included on the surface of the copper layer. These metal materials can include other elements.

The first side electrode E1 can include at least one conductive material (metal) selected from the group consisting of copper (Cu), nickel (Ni), tin (Sn), silver (Ag), gold (Au), platinum (Pt), palladium (Pd), indium (In), bismuth (Bi), and antimony (Sb). More specifically, the first side electrode E1 includes at least one conductive material selected from the group consisting of Cu, Ni, Sn, Ag, Au, Pd, Pt, Cu—Ni, Cu—Sn, Ni—Sn, Sn—Ag, Sn—In, Sn—Bi, Sn—Au, Sn—Sb, Sn—Pd, and pastes of these metal materials. The first side electrode E1 may be composed of a single layer, but may also be formed by stacking a plurality of conductive layers (metal layers) as described above. The materials of the anode terminal 1, the cathode terminal 2, and the second side electrode E2 can be set similarly to the material of the first side electrode E1, respectively.

The anode electrode layer 8 illustrated in FIG. 2 includes a first metal (aluminum). The insulating regions (10, 10B) as mixed regions and the solid electrolyte layers (12, 12B) also include the first metal (aluminum) as a roughened layer.

The material of the dielectric layers (9, 9B) illustrated in FIG. 2 is, for example, aluminum oxide. The thickness of the dielectric layers (9, 9B) is, for example, 1 nm or more and 1 μm or less.

The conductive polymer (compound) included in the solid electrolyte layers (12, 12B) and the conductive polymer layers on their surfaces can include at least one selected from the group consisting of polypyrrole, polyaniline, polythiophene, polyfuran, and derivatives thereof. As the conductive polymer, poly(3,4-ethylenedioxythiophene) (PEDOT) and polypyrrole (PPy) are preferably used. These may be used alone or in a mixture of two or more. An appropriate dopant can be added to these materials to provide excellent conductivity.

The conductive layers (13, 13B) are, for example, composed of an adhesive conductive layer (e.g., carbon paste). The adhesive conductive layer includes a conductor and an adhesive. The conductor of the adhesive conductive layer is a material including carbon (e.g., graphite) or a metal. The adhesive of the adhesive conductive layer is a resin such as a phenolic resin, a urea resin, an epoxy resin, a polyester resin, or a polyimide resin, or a hydrocarbon compound such as paraffin oil. Carbon paste is a mixture of graphite powder and an adhesive, and can be used for the conductive layers (13, 13B). Further, the conductive layers (13, 13B) can be formed by a printing method.

As a metal conductive layer constituting the cathode electrode layers (14, 14B), copper (Cu), nickel (Ni), silver (Ag), tin (Sn), or the like can be used, and these metal conductive layers can be plating layers formed using a plating method. These metal conductive layers can also be formed by any method such as sputtering. When forming a plating layer by an electroless plating method, the underlying adhesive conductive layer can include a catalytic metal. The catalytic metal is a noble metal having catalytic activity for electroless plating, and palladium (palladium-based material), gold, platinum, rhodium, or the like can be used, with palladium being particularly preferably used. These may be used alone or in a mixture of two or more. An additional metal film (thickening) may be formed by an electrolytic plating method on a metal film formed by electroless plating or sputtering.

Generally, for copper plating, a copper sulfate bath, a pyrophosphate copper bath, a cyanide copper bath, a fluoborate copper bath, or the like can be used. For nickel plating, a Watts bath (nickel sulfate), a sulfamate bath (nickel sulfamate), an all-chloride bath (nickel chloride), or the like can be used. For tin plating, a sulfate bath, a sulfonate bath, or the like can be used. Various plating methods are known and can be applied to the formation of each plating layer.

The material of the insulating layers (11, 11B) includes the same first resin (e.g., epoxy resin) as the insulating regions (10, 10B) and a filler. A filler basically does not enter the insulating regions (10, 10B). Therefore, the filler content in the insulating regions (10, 10B) is smaller than the filler content in the insulating layers (11, 11B).

The protective layers (15, 15B) are made of a resist material including a resin, and preferably made of a material including a resin and an inorganic material. As the inorganic material, a filler such as silica (silicon oxide) can be used. As the resin material, a thermosetting resin such as polyimide or an epoxy resin can be used. In this example, protective layers (15, 15B) in which silica is added to an epoxy resin are used. The resist material can be a liquid material dissolved in a suitable solvent during manufacturing. The protective layers (15, 15B) can be omitted.

As for the formation method of the protective layers (15, 15B), there are various methods. For example, a screen printing method or a gravure printing method (transfer) can be used. In this example, a screen printing method is used. The formation process of each element on the upper surface side and the formation process of each element on the lower surface side can be performed simultaneously or in different periods. Performing them simultaneously can shorten the manufacturing time.

The insulating portion 30 may include a material A made of a resist material including a resin, or a material B including a resin and a filler of an inorganic material. As this resin material, a thermosetting resin such as an epoxy resin can be used. As an example of the material B, an epoxy resin containing a filler of silica can be used. As such a resin, a phenolic resin, a methacrylic resin, an epoxy resin, a silicone resin, a polycarbonate, a polyethylene terephthalate, a polyamide, a polyimide, a polybutadiene, a polyethylene, a polystyrene, or the like can be exemplified. Further, as an inorganic material constituting the filler, silica (SiO₂), aluminum oxide (Al₂O₃), aluminum nitride (AlN), or the like can be exemplified.

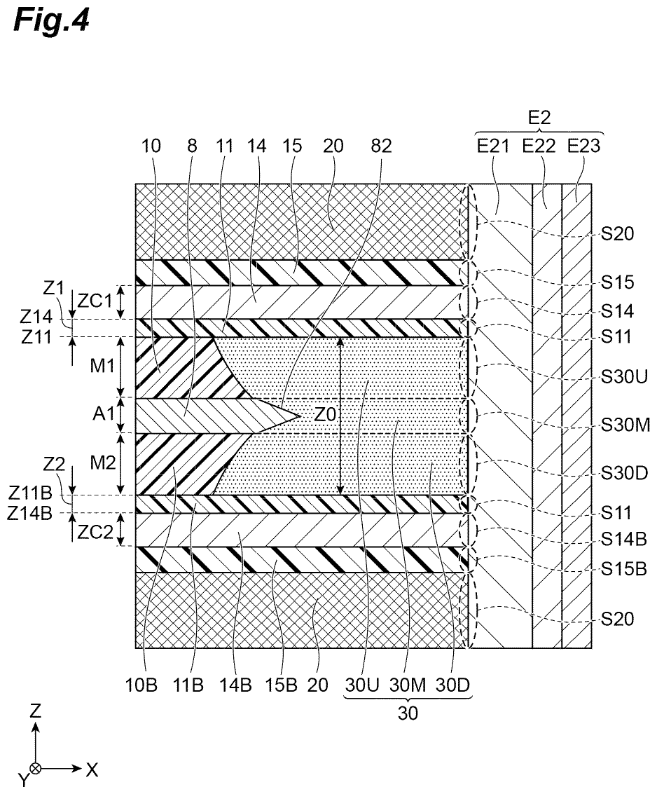

FIG. 4 is an enlarged view of a vicinity region of a second side electrode in a solid electrolytic capacitor element (second example).

The solid electrolytic capacitor element of this example is different from that illustrated in FIG. 3 in that the insulating portion 30 has a three-layer structure, and other configurations are the same as those illustrated in FIG. 3.

In the second example, a third connection portion S30U is a portion where a side surface of the upper layer 30U and the second side electrode E2 are in contact, adhered, and connected. A fourth connection portion S30M is a portion where a side surface of the middle layer 30M and the second side electrode E2 are in contact, adhered, and connected. A fifth connection portion S30D is a portion where a side surface of the lower layer 30D and the second side electrode E2 are in contact, adhered, and connected.

An adhesion strength IC(14) at the first connection portion S14 and an adhesion strength IC(14B) at the second connection portion S14B are substantially the same (IC(14)≈IC(14B)). Substantially the same can include an error of 30%. An adhesion strength IC(30U) of the third connection portion S30U, an adhesion strength IC(30M) of the fourth connection portion S30M, and an adhesion strength IC(30D) of the fifth connection portion S30D are each smaller than the adhesion strengths IC(14) and IC(14B) of the cathode electrode layer (IC(30U)<IC(14), IC(30M)<IC(14), IC(30D)<IC(14), IC(30U)<IC(14B), IC(30M)<IC(14B), IC(30D)<IC(14B)). When a heating test is performed, these adhesion strengths can also be expressed by the temperature at which a disconnected state occurs. Even when the third connection portion S30U, the fourth connection portion S30M, or the fifth connection portion S30D enters a disconnected state by heating the solid electrolytic capacitor, the first connection portion S14 and the second connection portion S14B can maintain a connected state. That is, the solid electrolytic capacitor can operate, and the resistance to environmental changes is enhanced.

In this example, the adhesion strength IC(30M) of the middle layer 30M is higher than both the adhesion strengths IC(30U) and IC(30D) of the upper layer 30U and the lower layer 30D (IC(30U)<IC(30M), IC(30D)<IC(30M)). The filler content of the middle layer 30M is higher than the filler content of the upper layer 30U and the lower layer 30D, and the adhesion strength is also higher.

In order to increase the adhesion strength in the vicinity of the connection portions of the upper cathode electrode layer 14 and the lower cathode electrode layer 14B, the layers adjacent to the respective cathode electrode layers (the first insulating layer 11, the first protective layer 15, the upper intermediate layer 20, the second insulating layer 11B, the second protective layer 15B, the lower intermediate layer 20) contain a resin and a filler, thereby increasing the adhesion strength at the respective connection portions. The adhesion strength of these connection portions can be set higher than the adhesion strength of the upper layer 30U and the lower layer 30D in the insulating portion 30.

The insulating portion 30 includes an upper layer 30U (first resin layer) located on the first insulating layer 11 side, a lower layer 30D (second resin layer) located on the second insulating layer 11B side, and a middle layer 30M (intermediate resin layer) interposed between the upper layer 30U (first resin layer) and the lower layer 30D (second resin layer) and having a higher filler content than both the upper layer 30U (first resin layer) and the lower layer 30D (second resin layer). In the insulating portion 30, since the adhesion strength of the middle layer 30M is partially high, large-scale destruction of the insulating portion 30 can be suppressed, and disconnection of the connection portion in the cathode electrode layer can be further suppressed.

A thickness M1 of the upper insulating region 10 is basically equal to a thickness of the upper layer 30U. A thickness M2 of the lower insulating region 10B is basically equal to a thickness of the lower layer 30D. A thickness A1 of the anode electrode layer 8 is basically equal to a thickness of the middle layer 30M. A thickness Z1 (μm) of the first insulating layer 11, a thickness Z2 (μm) of the second insulating layer 11B, a thickness M1 (μm) of the upper layer 30U (first resin layer), a thickness M2 (μm) of the lower layer 30D (second resin layer), a thickness A1 (μm) of the middle layer 30M (intermediate resin layer), a filler content C_{Z1} (mass %) in the first insulating layer 11, a filler content C_{Z2} (mass %) in the second insulating layer 11B, a filler content C_{M1} (mass %) in the upper layer 30U (first resin layer), a filler content C_{M2} (mass %) in the lower layer 30D (second resin layer), and a filler content C_{A1} (mass %) in the middle layer 30M (intermediate resin layer) can have the following relationship: C_{M1}<C_{Z1}, C_{M2}<C_{Z2}, C_{M1}<C_{A1}, and C_{M2}<C_{A1}. As a result, the environmental resistance of the solid electrolytic capacitor is enhanced as described later. Further, Z1<M1, Z2<M2, and A1<M1 can be satisfied.

In the solid electrolytic capacitor, C_{Z1}≤C_{A1} and C_{Z2}≤C_{A1} can be satisfied, and since stress is applied from both the upper and lower directions of the fourth connection portion S30M when the third connection portion S30U and the fifth connection portion S30D are destroyed, increasing the filler content C_{A1} improves the adhesion strength of the fourth connection portion S30M, which has the effect of making destruction at the fourth connection portion S30M less likely to occur. As long as the effect of suppressing disconnection of the connection portion in the cathode electrode layer is not impaired, C_{A1}<C_{Z1} and C_{A1}<C_{Z2} may be satisfied.

The insulating portion 30 includes, at least in the upper layer and the lower layer, a constituent material (referred to as material A) included in the upper insulating region 10 and the lower insulating region 10B. The middle layer 30M of the insulating portion 30 mainly includes a constituent material (referred to as material B) of the protective insulator 16. The resin included in the material A and the resin included in the material B may be the same or different materials.

The material A is made of a resist material including a resin, and can include a filler of an inorganic material such as silica as necessary. As this resin material, a thermosetting resin such as polyimide or an epoxy resin can be used. As an example of the material A, an epoxy resin can be used.

The material B is made of a resin including a filler of an inorganic material such as silica. As this resin material, a thermosetting resin such as an epoxy resin can be used. As an example of the material B, an epoxy resin containing a filler of silica can be used. The upper layer 30U and the lower layer 30D of the insulating portion 30 include an epoxy resin included in the material A and the material B, and as an example, the filler content is small. The middle layer 30M of the insulating portion 30 mainly includes the material B, which includes an epoxy resin and a filler, and as an example, the filler content is higher than that of the upper layer 30U and the lower layer 30D. As a resin that can be included in the material A and the material B, a phenolic resin, a methacrylic resin, an epoxy resin, a silicone resin, a polycarbonate, a polyethylene terephthalate, a polyamide, a polyimide, a polybutadiene, a polyethylene, a polystyrene, or the like can be exemplified. Further, as an inorganic material constituting the filler, silica (SiO₂), aluminum oxide (Al₂O₃), aluminum nitride (AlN), or the like can be exemplified.

Next, the superiority of the solid electrolytic capacitor elements of the first and second examples over a comparative example will be described.

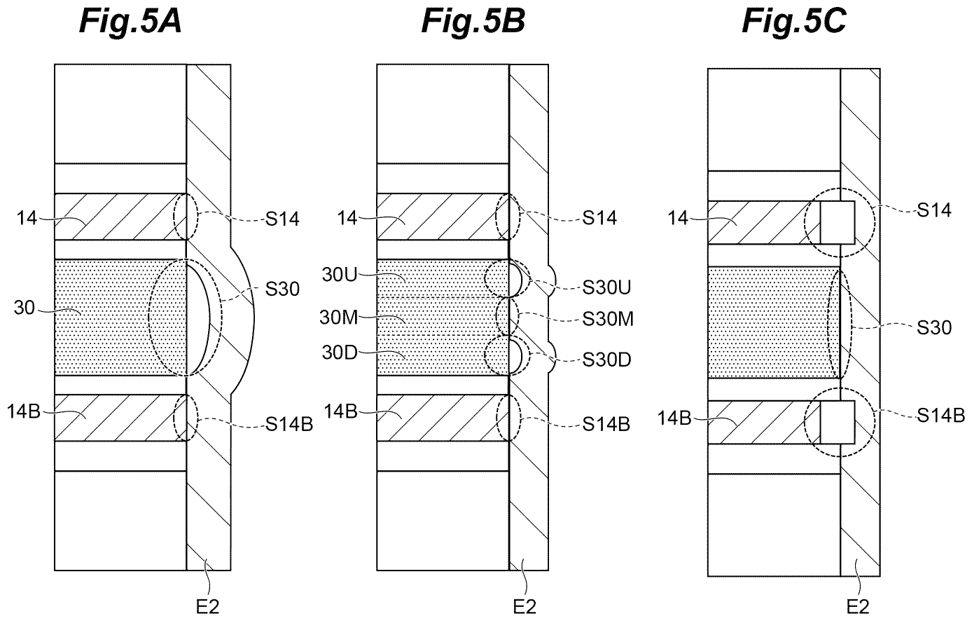

FIG. 5A is a schematic diagram illustrating a vicinity region of a second side electrode of a solid electrolytic capacitor element according to a first example. FIG. 5B is a schematic diagram illustrating a vicinity region of a second side electrode of a solid electrolytic capacitor element according to a second example. FIG. 5C is a schematic diagram illustrating a vicinity region of a second side electrode of a solid electrolytic capacitor element according to a comparative example.

As illustrated in FIG. 5A, the insulating portion 30 of the first example has a single-layer structure, and the single-layer structure is made of, for example, only a resin such as an epoxy resin. The insulating portion 30 can also contain a resin and a trace amount of filler. When the temperature (humidity) is increased, the connection portion S30 breaks and enters a disconnected state before the cathode electrode layers (14, 14B) and the second side electrode E2 separate and become disconnected. More specifically, when the second side electrode E2 thermally expands, the connection portion S30 delaminates from the insulating portion 30, a gap is formed between them, and stress in the vicinity of the cathode electrode layers (14, 14B) is relieved.

As illustrated in FIG. 5B, the insulating portion 30 of the second example has a three-layer structure, and the three-layer structure includes an upper layer 30U made of only a resin, a middle layer 30M including a resin and a filler, and a lower layer 30D made of only a resin. Since the adhesion strength of the middle layer 30M is higher than both the upper layer 30U and the lower layer 30D, the middle layer 30M does not delaminate from the second side electrode E2. On the other hand, the upper layer 30U and the lower layer 30D delaminate from the second side electrode E2 with thermal expansion. That is, when the temperature (humidity) is increased, the connection portions (S30U, S30D) break and enter a disconnected state before the cathode electrode layers (14, 14B) and the second side electrode E2 separate and become disconnected. More specifically, when the second side electrode E2 thermally expands, the second side electrode E2 delaminates from the insulating portion 30 at these connection portions (S30U, S30D), a gap is formed between them, and stress in the vicinity of the cathode electrode layers (14, 14B) is relieved.

As illustrated in FIG. 5C, the insulating portion 30 of the comparative example has a single-layer structure, and the single-layer structure includes a resin and a filler. An example of the filler content of the insulating portion 30 in the comparative example is the same as the filler content of the middle layer 30M in the second example. The filler content C_{A1} in the insulating portion 30 of the comparative example and the middle layer 30M of the second example is 40 (mass %)≤C_{A1}≤90 (mass%). The filler content in the insulating portion 30 of the first example is set to be smaller than the lower limit of the filler content in the insulating portion 30 of the comparative example, and can be 0 (mass %)≤C_{A1}≤30 (mass %).

The insulating portion 30 of the first example has a single-layer structure, and the insulating portion 30 of the second example has a three-layer structure, but these structures are not limited as long as the insulating portion 30 has a portion with a lower filler content than the insulating layers (11, 11B) at the connection portion with the second side electrode E2. By having a portion with a lower filler content than the insulating layers (11, 11B) at the connection portion with the second side electrode E2, the insulating portion 30 breaks and enters a disconnected state at that portion before the cathode electrode layers (14, 14B) and the second side electrode E2 separate and become disconnected due to environmental changes such as thermal expansion.

Next, a method of manufacturing a solid electrolytic capacitor will be briefly described.

First, a solid electrolytic capacitor sheet having the laminated structure of the solid electrolytic capacitor element CE illustrated in FIG. 2 is manufactured. This sheet does not include the insulating portion 30, and this region is filled with the same material as the insulating regions (10, 10B). The method of manufacturing the solid electrolytic capacitor sheet includes (a) a metal sheet preparation step, (b) an insulating region formation step, (c) a solid electrolyte layer formation step, (d) a conductive layer formation step, (e) a cathode electrode layer formation step, (f) a protective layer formation step, and (g) a cathode electrode layer etching and dividing step, and these steps are sequentially executed.

(a) In the metal sheet preparation step, a metal sheet in which a roughened layer is formed on the upper and lower surfaces of the anode electrode layer 8 is prepared. The roughened layer is formed by first roughening both surfaces of the metal sheet by etching or the like, and then subjecting both surfaces of the metal sheet to chemical conversion treatment (oxide film formation treatment and/or anodic oxidation) to form an oxide layer on these surfaces. On the upper surface of the anode electrode layer 8, a first dielectric layer (oxide layer: in this example, an Al₂O₃ layer) is formed, and on the lower surface, a second dielectric layer 9B (oxide layer: in this example, an Al₂O₃ layer) is formed.

(b) In the insulating region formation step, a resist (resin+filler) having a lattice pattern is applied onto the surface of the roughened layer to allow the resin to infiltrate into the roughened layer, thereby forming insulating regions (10, 10B). A filler does not infiltrate into the insulating regions (10, 10B), but a resist including a filler remains on the surface thereof to form insulating layers (11, 11B). As a method of applying the resist, various methods are known. For example, screen printing, gravure printing, spray coating, and the like are known methods. In this example, the screen printing method is used. The material of the resist is material A (e.g., a mixture of epoxy resin and silica filler). As fillers other than silica, alumina and aluminum hydroxide are known.

When forming the insulating regions (10, 10B) of the first example, a protective film is applied in advance as necessary on the surface region of the roughened layer adjacent to the region where the second side electrode E2 is to be formed. After forming the protective film, the above-described resist is applied to form the insulating regions. The protective film can be composed of a resist having high viscosity, high filler content, and low infiltration rate into the roughened layer. As a result, an insulating region is not formed directly under the resist, and the state of the roughened layer is maintained, so that in the subsequent etching step in the groove, the roughened layer in that portion is etched, and an insulating material can be filled into the etched region to form the insulating portion 30. When forming the insulating regions (10, 10B) of the second example, pre-formation of a protective film is not necessary, and during etching in the groove, the upper and lower regions of the region where the insulating portion 30 is to be formed are composed of insulating regions formed by infiltrating resin into the roughened layer.

(c) In the solid electrolyte layer formation step, a conductive polymer is supplied into the openings of the lattice pattern and infiltrated into the roughened layer to form solid electrolyte layers (12, 12B). As a method of introducing the conductive polymer, various methods are known. For example, a coating method, a chemical oxidation polymerization method, an electrolytic polymerization method, or the like is known.

(d) In the conductive layer formation step, conductive layers (13, 13B) are formed on the solid electrolyte layers (12, 12B). Each conductive layer may be a single layer, but may also be consist of two or more layers. As a formation method, a method of applying a material of the conductive layer (e.g., carbon paste) can be used. A screen printing method, a gravure printing method (transfer), a supply method using a dispenser, or the like can be used.

(e) In the cathode electrode layer formation step, cathode electrode layers (14, 14B) are formed on the conductive layers (13, 13B) using a plating method or the like. When forming the cathode electrode layer, first, an underlying layer with high adhesion, such as copper (Cu) or nickel-chromium alloy (NiCr), is formed by a sputtering method, and a plating layer is formed on the underlying layer. The material of the plating layer in this example is copper (Cu).

(f) In the protective layer formation step, protective films (15, 15B) made of a patterned resist are formed on the cathode electrode layers (14, 14B). For the formation of the protective layer, a screen printing method or a gravure printing method (transfer) can be used.

In (g) the cathode electrode layer etching and dividing step, using the protective films (15, 15B) as a mask, a part of the cathode electrode layers (14, 14B) is etched so that a part of the insulating layers (11, 11B) is exposed, and divided into a plurality of rectangular regions. As an etching solution, a ferric chloride aqueous solution, a cupric chloride aqueous solution, a mixed solution of sulfuric acid and hydrogen peroxide solution, or the like can be used. Through these steps, a solid electrolytic capacitor sheet is manufactured. The processing step of the elements on the upper side of the anode electrode layer 8 and the processing step of the elements on the lower side may be performed simultaneously or separately.

Next, a plurality of solid electrolytic capacitor sheets are stacked on the bottommost layer 20BTM as a support substrate illustrated in FIG. 1. An adhesive insulating layer (20) illustrated in the figure is disposed between each sheet, between the sheet and the support substrate, and on the topmost sheet. These sheet groups are adhered to manufacture a laminate sheet. A rotating blade is applied to the laminate sheet to form a groove along the Y-axis direction with the negative direction of the Z-axis as the depth direction. Similarly, a rotating blade is applied to the laminate sheet to form a groove along the X-axis direction with the negative direction of the Z-axis as the depth direction. An etching solution is introduced into the formed groove to etch both ends of the anode electrode layer 8, thereby forming a space between the side surface portion of the anode electrode layer 8 and the initial inner surface of the groove. As the etching solution, an alkaline solution such as a sodium hydroxide aqueous solution or an acidic solution such as sulfuric acid can be used. An appropriate additive may be added to the etching solution as necessary.

An insulating material constituting the protective insulator 16 is filled into the groove, and an insulating material is filled into the space between the side surface portion of the anode electrode layer 8 and the initial inner surface of the groove to form the insulating portion 30. In the first example, the insulating portion 30 is composed of a single layer uniformly filled with an insulating material. In the second example, in the etching step in the groove, the etching of the upper and lower layers of the region where the insulating portion is to be formed is not complete, and an insulating region made of a low-density resin remains in that region, so that the insulating portion 30 with a three-layer structure is formed. In this filling step, an insulating resin is supplied to the upper surface of the laminate sheet, and pressure is applied in the Z-axis direction to fill the insulating resin into the groove and the space. The form of the supplied insulating resin may be liquid or a solid sheet. As a filling method, a compression molding method, a transfer molding method, or an injection molding method using a liquid insulating resin can be used. As a filling method, a method of attaching a sheet-like resin sealing material to the surface of the laminate sheet and planarizing the resin sealing material with a press can also be used.

Next, a rotating blade is applied to the laminate sheet to form a groove along the Y-axis direction with the positive direction of the Z-axis as the depth direction, thereby exposing one side surface on which the first side electrode E1 is to be formed and the other side surface on which the second side electrode E2 is to be formed. Subsequently, the first side electrode E1 and the second side electrode E2 are formed on the inner surface of the groove by a plating method or the like. The formation position of the groove at this time is a position where the first side electrode E1 can contact one side surface of the anode electrode layer 8 and the second side electrode E2 can contact the other side surface of the cathode electrode layers (14, 14B). Finally, a rotating blade is applied to the laminate sheet, and dicing is performed in a lattice pattern to singulate and cut out individual solid electrolytic capacitors. The anode terminal 1 and the cathode terminal 2 can be formed by patterning an electrode material on the bottommost layer after stacking the solid electrolytic capacitor elements to form the laminate and before forming the side electrodes.

The above-described solid electrolytic capacitor was manufactured, and its environmental resistance was evaluated.

Since the solid electrolytic capacitors of the first and second examples described above include the second mixed regions (40, 40B), the adhesion strength at the corresponding locations increases, and the environmental resistance to changes in temperature (humidity) and the like is enhanced. When the following environmental test was conducted on the solid electrolytic capacitors of the first and second examples, it was confirmed that the environmental resistance of the solid electrolytic capacitor was enhanced by including the second mixed regions (40, 40B). This will be described in detail below.

### Experimental Conditions

First, although the number of solid electrolytic capacitor elements CE illustrated in FIG. 1 is two, following the example of FIG. 1, the number of solid electrolytic capacitor elements CE was increased to four, and a solid electrolytic capacitor formed by stacking them was manufactured. The resin contained in the insulating layer (20) was an epoxy resin, the glass cloth was composed of bundled glass yarns of a plurality of filaments, and each filament was made of silica glass whose main component is SiO₂. The silica glass used as an example is E-glass. As the material of the filament, glass including silica such as NE glass, or other known glass can be used.

The topmost layer 20TOP and the bottommost layer 20BTM include a resin and a glass cloth. This resin is an epoxy resin. This glass cloth has a plain weave structure composed of a plurality of glass yarns, and the thicknesses of the topmost layer 20TOP and the bottommost layer 20BTM are 150 (μm) and 200 (μm), respectively. The intermediate layer (20) includes an epoxy resin and a glass cloth, and has a thickness of 30 (μm).

In the solid electrolytic capacitor of the basic structure, the anode electrode layer 8 included in the solid electrolytic capacitor element is aluminum with a thickness of 25 (μm), the dielectric layers (9, 9B) are aluminum oxide, and the solid electrolyte layer (12, 12B) is formed of PEDOT impregnated in an aluminum roughened layer with a thickness of 50 (μm). The thickness of the anode electrode layer 8 corresponds to the thickness of its middle layer (intermediate insulating layer (30M)) when the insulating portion 30 has a three-layer structure.

The material of the conductive layers (13, 13B) is carbon paste, the cathode electrode layers (14, 14B) are copper (Cu) with a thickness of 1 to 20 (μm), and the protective layer 15 is a silica filler-containing epoxy resin (filler content=40 (mass %)) with a thickness of 20 (μm).

The insulating regions (10, 10B) are an aluminum roughened layer with a thickness of 50 (μm) containing an epoxy resin, and the insulating layers (11, 11B) are a silica filler-containing epoxy resin (filler content=50 to 80 (mass %)) with a thickness of 5 to 30 (μm). When the insulating portion 30 has a single-layer structure, it is an epoxy resin with a thickness of 50 to 300 (μm), and the filler content is 0 to 80 (mass %). When the insulating portion 30 has a three-layer structure, its upper and lower layers are each an epoxy resin with a thickness of 15 to 125 (μm), and the middle layer of the insulating portion 30 is a filler-containing epoxy resin (filler content=0 to 80 (mass %)) with a thickness of 20 to 200 (μm).

An aluminum sheet with roughened layers formed on its upper and lower surfaces is prepared, a resist including an epoxy resin and a silica filler is printed in a lattice pattern to form insulating regions (10, 10B) and insulating layers (11, 11B), and PEDOT is impregnated into the lattice openings to form solid electrolyte layers (12, 12B). On top of that, after forming an underlying layer of copper by a sputtering method, copper plating is applied on the underlying layer to form cathode electrode layers (14, 14B). Further, a protective layer (15) serving as a resist is formed thereon, a part of the protective layer is opened along the Y-axis direction, and the cathode electrode layer in the opening is etched.

Thereafter, four layers of sheets including the solid electrolytic capacitor elements prepared by these steps are prepared, stacked on a support substrate as a bottommost layer as illustrated in FIG. 1, and a laminate sheet is formed. A groove with the negative direction of the Z-axis as the depth direction is formed in this laminate sheet by applying a rotating blade to the laminate sheet. After etching the anode electrode layer in this solid electrolytic capacitor intermediate body, a filler-containing epoxy resin is filled into the groove. The laminate is covered with a protective insulator including a filler-containing epoxy resin. By forming side electrodes and electrode terminals and performing dicing for singulation, a solid electrolytic capacitor including four layers of solid electrolytic capacitor elements covered with a protective insulator is completed.

### Evaluation and Results

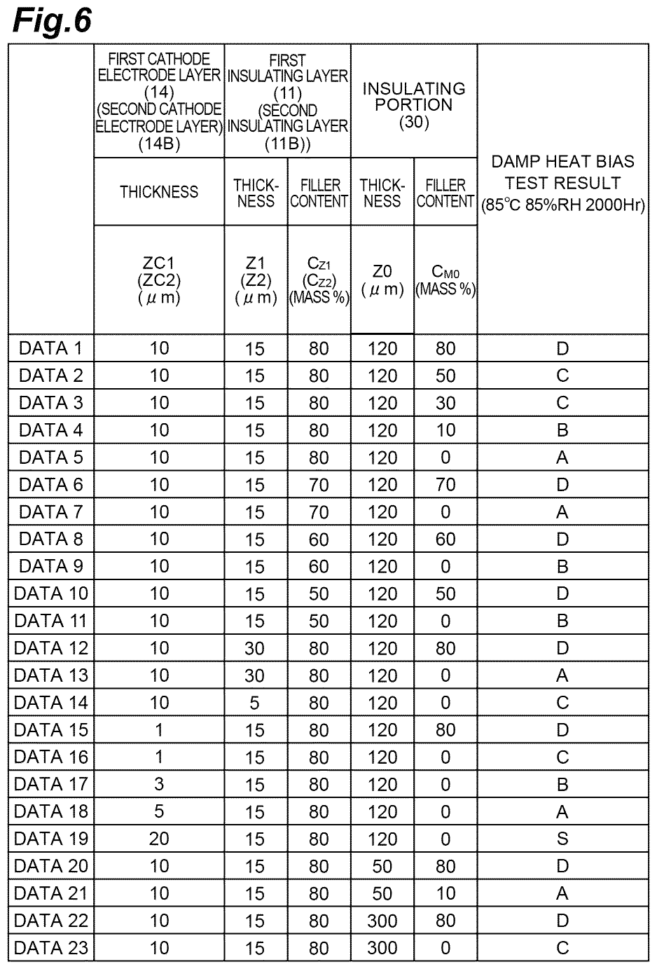

FIG. 6 is a chart illustrating parameters and evaluation results of each element in the first example.

The figure shows, for the solid electrolytic capacitor including the structure of the first example (FIG. 3), the thickness (ZC1 (μm)) of the first cathode electrode layer 14 (thickness ZC2 (μm) of the second cathode electrode layer 14B), the thickness (Z1 (μm)) of the first insulating layer 11 (thickness (Z2 (μm) of the second insulating layer 11B)), the filler content (C_{Z1} (mass %)) of the first insulating layer (filler content (C_{Z2} (mass %)) of the second insulating layer), the thickness (Z0 (μm)) of the insulating portion 30, and the filler content (C_{M0} (mass %)). The environmental resistance of the solid electrolytic capacitor was evaluated by conducting a damp heat bias test. The thickness of each layer was determined by observation with an optical microscope. When the surface of each layer was rough and had irregularities, the thickness was determined using the average height position obtained by the least squares method for the surface height position. Samples from each layer were heated in air at 600° C. for 1 h in an electric furnace to ash the resin and leave only the filler residue. The masses before and after ashing were measured with an electronic balance, and the filler content (by mass) was calculated from their ratio.

(Damp Heat Bias Test): In the damp heat bias test, a rated voltage (2.5 V) was applied for 2000 hours in an environment of a temperature of 85° C. and a humidity of 85% RH.

The product after the test was impregnated with an embedding resin and then cured, and its cross-section was exposed by polishing with waterproof abrasive paper. The presence or absence of disconnection between the second side electrode and the cathode electrode layer was observed on a cross-section magnified at a magnification of 100 times with an optical microscope. A damp heat bias test was conducted on n products (n=11) having one attribute parameter.

(Rating S): When the number of products in which disconnection was confirmed was 0, this solid electrolytic capacitor was evaluated as (Rating S) in the damp heat bias test.

(Rating A): When the number of products in which disconnection was confirmed was 1, this solid electrolytic capacitor was evaluated as (Rating A) in the damp heat bias test.

(Rating B): When the number of products in which disconnection was confirmed was 2, this solid electrolytic capacitor was evaluated as (Rating B) in the damp heat bias test.

(Rating C): When the number of products in which disconnection was confirmed was 3 to 5, this solid electrolytic capacitor was evaluated as (Rating C) in the damp-heat bias test. A product with (Rating C) can be used unless the usage environment is harsh. For example, a usage environment is not harsh if the time of the damp heat bias test is 1000 hours or the temperature of the damp heat bias test is 60° C. in the above test.

(Rating D): When the number of products in which disconnection was confirmed exceeded 5, this solid electrolytic capacitor was evaluated as (Rating D) in the damp heat bias test. A product with (Rating D) is a defective product.

The results of (Rating S) or (Rating A) were obtained in the experimental examples of Data 5, Data 7, Data 13, Data 18, Data 19, and Data 21. In all of these experimental examples, the filler content of the insulating portion 30 is 0 (mass %). In (Rating S), the thickness of the cathode electrode layers (14, 14B) is larger than the thickness of the cathode electrode layer of (Rating A).

Regarding the data of (Rating S) or (Rating A), the filler content C_{M0} (mass %) of the insulating portion is smaller than the filler content (C_{Z1} (mass%), C_{Z2} (mass %)) of the insulating layers (11, 11B). That is, the insulating portion 30 has a smaller adhesion strength in the vicinity of the side electrode than the insulating layer and the cathode electrode layer located in its vicinity, and when the environmental stress is high, it delaminates or the like, thereby suppressing the delamination of the cathode electrode layer. The data of (Rating B) and (Rating C) also have this relationship of filler content.

In other words, considering the data of (Rating S) to (Rating C), the filler content C_{Z1} (mass %) in the first insulating layer 11, the filler content C_{Z2} (mass %) in the second insulating layer 11B, and the filler content C_{M0} (mass %) in the insulating portion 30 satisfy the relationship of C_{M0}<C_{Z1} and C_{M0}<C_{Z2}. On the other hand, the data of (Rating D) do not satisfy these relationships.

When the filler content C_{M0} (mass %) of the insulating portion is increased with respect to the data of (Rating A), the evaluation rank deteriorates to (Rating B) and (Rating C) as shown in Data 2-4. When the difference between the filler content C_{M0} (mass %) of the insulating portion and the filler content (C_{Z1} (mass%), C_{Z2} (mass %)) in the insulating layer becomes 0 (mass %), the result of (Rating D) is obtained.

Regarding the thickness of the cathode electrode layer, there is a tendency for the evaluation rank to deteriorate as the thickness becomes thinner. This is considered to be because the adhesion area between the cathode electrode layer and the second side electrode becomes smaller, making it easier to delaminate. When the relationship of the filler content in the data of (Rating C) or higher is satisfied, the thickness (ZC1 (μm), ZC2 (μm)) of each cathode electrode layer can be further set to 1 (μm)≤ZC1 (μm)≤20 (μm) and 1 (μm)≤ZC2 (μm)≤20 (μm). Preferably, it can be set to 3 (μm)≤ZC1 (μm)≤20 (μm) and 3 (μm)≤ZC2 (μm)≤20 (μm). Preferably, it can be set to 5 (μm)≤ZC1 (μm)≤20 (μm) and 5 (μm)≤ZC2 (μm)≤20 (μm). Preferably, it can be set to 10 (μm)≤ZC1 (μm)≤20 (μm) and 10 (μm)≤ZC2 (μm)≤20 (μm). The upper limit can be further increased, but from the viewpoint of material cost and the like, a sufficient thickness is all that is necessary.

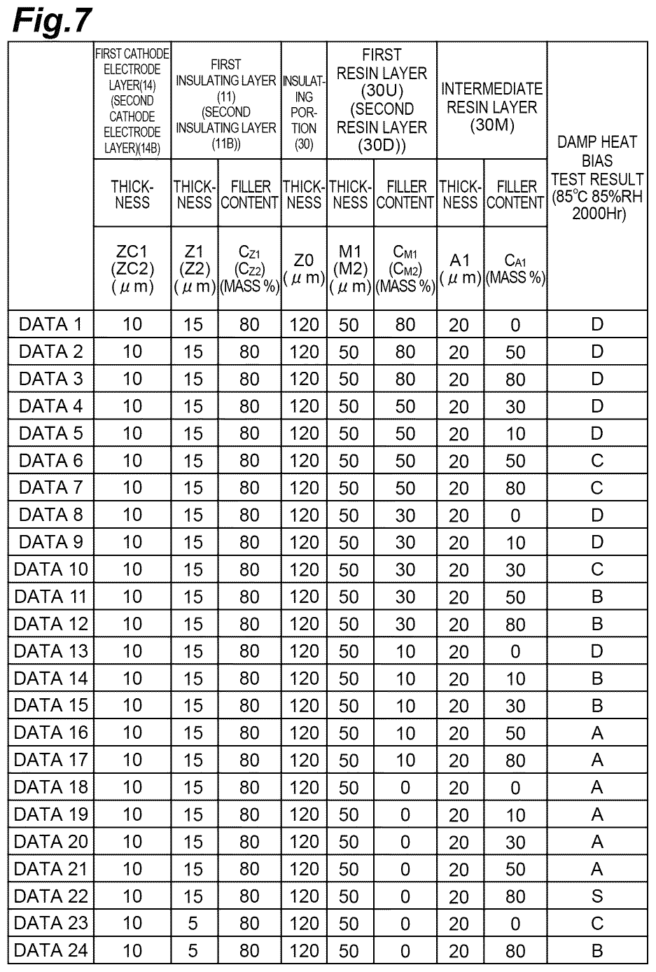

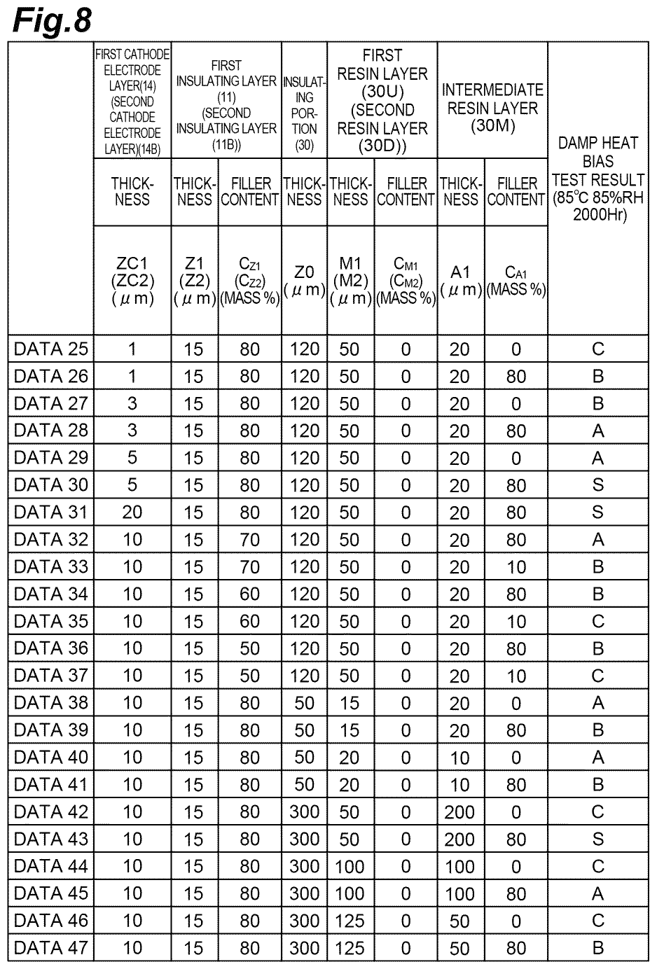

FIGS. 7 and 8 are charts illustrating parameters and evaluation results of each element in the second example.

The figures show, for the solid electrolytic capacitor including the structure of the second example (FIG. 4), in addition to the above-described ZC1 (μm) (ZC2 (μm)), Z1 (μm) (Z2 (μm)), and C_{Z1} (mass%) (C_{Z2} (mass%)), the thickness M1 (μm) and filler content C_{M1} (mass %) of the first resin layer (30U), and the thickness (M2 (μm)) and filler content C_{M2} (mass %) of the second resin layer (30D). Further, the thickness (A1 (μm)) and filler content (C_{A1} (mass %)) of the intermediate insulating layer (30M) are shown. The environmental resistance of the solid electrolytic capacitor was evaluated by conducting a damp heat bias test.

The method of assigning evaluation rankings (Rating S to Rating D) is the same as in the previous case.

The results of (Rating S) or (Rating A) were obtained in the experimental examples of Data 16 to Data 22, Data 28 to Data 32, Data 38, Data 40, Data 43, and Data 45. These experimental examples satisfy at least the relationships of C_{M1}<C_{Z1}, C_{M2}<C_{Z2}, C_{M1}≤C_{A1}, and C_{M2}≤C_{A1}. When the filler content (C_{M1}, C_{M2}) of the first and second resin layers is smaller than the filler content (C_{A1}) in the intermediate resin layer (30M), the adhesion strength between the first and second resin layers and the second side electrode becomes relatively small, and when the environmental stress is high, it delaminates or the like, thereby suppressing the delamination of the cathode electrode layer. Further, the filler content (C_{Z1}, C_{Z2}) in the first insulating layer 11 and the second insulating layer 11B located in the vicinity of the cathode electrode layer is higher than the filler content (C_{M1}, C_{M2}) of the first and second resin layers in the insulating portion, and the delamination of the cathode electrode layer is relatively suppressed. The data of (Rating B) and (Rating C) also have this relationship of filler content. On the other hand, the data for which the result of (Rating D) is obtained do not satisfy these relationships.

When the filler content of the first and second insulating layers (30U, 30D) in the insulating portion 30 is increased, the evaluation ranking tends to deteriorate. It is considered that the larger the thickness (ZC1, ZC2) of the cathode electrode layer, the less likely the cathode electrode layer is to delaminate. The thickness (ZC1 (μm), ZC2 (μm)) of each cathode electrode layer can be set to 1 (μm)≤ZC1 (μm)≤20 (μm) and 1 (μm)≤ZC2 (μm)≤20 (μm). Preferably, it can be set to 3 (μm)≤ZC1 (μm)≤20 (μm) and 3 (μm)≤ZC2 (μm)≤20 (μm). Preferably, it can be set to 5 (μm)≤ZC1 (μm)≤20 (μm) and 5 (μm)≤ZC2 (μm)≤20 (μm). Preferably, it can be set to 10 (μm)≤ZC1 (μm)≤20 (μm) and 10 (μm)≤ZC2 (μm)≤20 (μm). The upper limit can be further increased, but from the viewpoint of material cost and the like, a necessary thickness is sufficient.

It should be noted that when the range of any parameter P is given by Pmin≤P≤Pmax in the range of various parameters, it may be set to (Pmin+ΔP)≤P≤(Pmax−ΔP), where ΔP=(Pmax−Pmin)×R %, and R may be set to R=10, or may be set to R=20, R=30, or R=40. Also, when any parameter P is a specific single numerical value, its error range may be set to P×95%≤P≤P×105%.

As described above, the solid electrolytic capacitor of the first aspect comprises: a first solid electrolyte layer 12 disposed between an anode electrode layer 8 and a first cathode electrode layer 14; a second solid electrolyte layer 12B disposed between the anode electrode layer 8 and a second cathode electrode layer 14B; a first side electrode E1 in contact with a first side surface 81 of the anode electrode layer 8; a second side electrode E2 in contact with a side surface of the first cathode electrode layer 14 and a side surface of the second cathode electrode layer; an insulating portion 30 disposed between a second side surface of the anode electrode layer and the second side electrode E2, the insulating portion including a resin; a first insulating layer 11 disposed between the first cathode electrode layer 14 and the insulating portion 30 and including a resin and a filler; and a second insulating layer 11B disposed between the second cathode electrode layer 14B and the insulating portion 30 and including a resin and a filler, wherein a filler content C_{Z1} (mass %) of the first insulating layer 11, a filler content C_{Z2} (mass %) of the second insulating layer 11B, and a filler content C_{M0} (mass %) of the insulating portion 30 satisfy C_{M0}<C_{Z1} and C_{M0}<C_{Z2}.

The solid electrolytic capacitor of the second aspect comprises: a first solid electrolyte layer 12 disposed between an anode electrode layer 8 and a first cathode electrode layer 14; a second solid electrolyte layer 12B disposed between the anode electrode layer 8 and a second cathode electrode layer 14B; a first side electrode E1 in contact with a first side surface 81 of the anode electrode layer 8; a second side electrode E2 in contact with a side surface of the first cathode electrode layer 14 and a side surface of the second cathode electrode layer 14B; an insulating portion 30 disposed between a second side surface of the anode electrode layer 8 and the second side electrode E2 and including a resin; a first insulating layer 11 disposed between the first cathode electrode layer 14 and the insulating portion 30 and including a resin and a filler; and a second insulating layer 11B disposed between the second cathode electrode layer 14B and the insulating portion 30 and including a resin and a filler, wherein the insulating portion 30 comprises: a first resin layer (30U) located on a side of the first insulating layer 11; a second resin layer (30D) located on a side of the second insulating layer 11B; and an intermediate resin layer (30M) disposed between the first resin layer (30U) and the second resin layer (30D) and having a filler content higher than that of each of the first resin layer and the second resin layer, and wherein a filler content C_{Z1} (mass %) of the first insulating layer 11, a filler content C_{Z2} (mass %) of the second insulating layer 11B, a filler content C_{M1} (mass %) of the first resin layer (30U), a filler content C_{M2} (mass %) of the second resin layer (30D), and a filler content C_{A1} (mass %) of the intermediate resin layer (30M) satisfy C_{M1}<C_{Z1}, C_{M2}<C_{Z2}, C_{M1}<C_{A1}, and C_{M2}<C_{A1}.

The solid electrolytic capacitor of the third aspect satisfies C_{Z1}≤C_{A1} and C_{Z2}≤C_{A1}.

In the solid electrolytic capacitor of the fourth aspect, the second side electrode E2 comprises a plurality of stacked electrode layers.

In the solid electrolytic capacitor of the fifth aspect, the second side electrode E2 comprises a first electrode layer E21, a second electrode layer E22, and a third electrode layer E23, wherein the first electrode layer E21 includes copper (Cu) or silver (Ag) and is in contact with the first cathode electrode layer 14 and the second cathode electrode layer 14B, the second electrode layer E22 includes nickel (Ni) and is disposed between the first electrode layer E21 and the third electrode layer E23, and the third electrode layer E23 includes tin (Sn) or gold (Au).

In the solid electrolytic capacitor of the sixth aspect, the second electrode layer E22 has a thickness of 1 μm or more and 5 μm or less.

In the solid electrolytic capacitor of the seventh aspect, the first electrode layer E21 has a thickness of 5 μm or more and 15 μm or less, and the second electrode layer E22 has a thickness of 1 μm or more and 5 μm or less.

In the solid electrolytic capacitor of the eighth aspect, the first electrode layer E21 has a thickness of 5 μm or more and 15 μm or less, the second electrode layer E22 has a thickness of 1 μm or more and 5 μm or less, and the third electrode layer E23 includes tin (Sn) and has a thickness of 3 μm or more and 7 μm or less.

In the solid electrolytic capacitor of the ninth aspect, the first electrode layer E21 has a thickness of 5 μm or more and 15 μm or less, the second electrode layer E22 has a thickness of 1 μm or more and 5 μm or less, and the third electrode layer E23 includes gold (Au) and has a thickness of more than 0 μm and 1 μm or less.

The solid electrolytic capacitor of the tenth aspect further comprises an insulating region (10, 10B) disposed between the anode electrode layer 8 and the insulating portion 30, wherein the insulating region comprises a first metal and a first resin.

In the solid electrolytic capacitor of the eleventh aspect, the first metal includes aluminum, and the first resin includes a thermosetting resin.

The solid electrolytic capacitor of the twelfth aspect includes a dielectric layer 9 formed between the first solid electrolyte layer 12 and the anode electrode layer 8, wherein the dielectric layer 9 comprises an oxide of a first metal (e.g., aluminum) and has a thickness of 1 nm or more and 1 μm or less.

In the solid electrolytic capacitor of the thirteenth aspect, the first cathode electrode layer 14 includes copper and has a thickness of 1 μm or more and 20 μm or less, and the second cathode electrode layer 14B includes copper and has a thickness of 1 μm or more and 20 μm or less.

In the solid electrolytic capacitor of the fourteenth aspect, the first insulating layer 11 includes a resin and a filler, and a filler content C_{Z1} of the first insulating layer 11 is 50 mass% or more and 80 mass% or less, and the second insulating layer 11B includes a resin and a filler, and a filler content C_{Z2} of the second insulating layer 11B is 50 mass% or more and 80 mass% or less.

In the solid electrolytic capacitor of the fifteenth aspect, the insulating portion 30 includes a resin and a filler, and a filler content C_{M0} is 0 (mass %) or more and 30 (mass %) or less.

In the solid electrolytic capacitor of the sixteenth aspect, a filler content C_{A1} of the intermediate resin layer (30M) is 30 (mass %) or more and 80 (mass %) or less.

In the solid electrolytic capacitor of the seventeenth aspect, a filler content C_{M1} of the first resin layer (30U) is 0 mass% or more and 10 mass% or less, and a filler content C_{M2} of the second resin layer (30D) is 0 (mass %) or more and 10 (mass %) or less.

In the solid electrolytic capacitor of the eighteenth aspect, an adhesion strength at an interface between the second side electrode E2 and the insulating portion 30 is smaller than an adhesion strength at an interface between the second side electrode E2 and the first cathode electrode layer 14 or at an interface between the second side electrode E2 and the second cathode electrode layer 14B.

In the solid electrolytic capacitor of the nineteenth aspect, an adhesion strength at an interface between the second side electrode E2 and the intermediate resin layer (30M) is greater than an adhesion strength at an interface between the second side electrode E2 and the first resin layer (30U) or at an interface between the second side electrode E2 and the second resin layer (30D).

In the solid electrolytic capacitor of the twentieth aspect, the solid electrolytic capacitor comprises a laminate 100 including a plurality of solid electrolytic capacitor elements CE; and an intermediate layer 20 interposed between the solid electrolytic capacitor elements, and including a glass cloth and a resin, wherein each of the solid electrolytic capacitor elements CE has a structure including the anode electrode layer 8, the first cathode electrode layer 14, the first solid electrolyte layer 12, the second cathode electrode layer 14B, the second solid electrolyte layer 12B, the insulating portion 30, the first insulating layer 11, and the second insulating layer 11B.

In the solid electrolytic capacitor of the twenty-first aspect, the solid electrolytic capacitor comprises a laminate 100 including a plurality of stacked solid electrolytic capacitor elements CE, wherein each of the solid electrolytic capacitor elements CE has a structure including the anode electrode layer 8, the first cathode electrode layer 14, the first solid electrolyte layer 12, the second cathode electrode layer 14B, the second solid electrolyte layer 12B, the insulating portion 30, the first insulating layer 11, and the second insulating layer 11B; and wherein the laminate 100 includes: a topmost layer (20TOP) including a glass cloth and a resin, and a bottommost layer (20BTM) including a glass cloth and a resin.

It is to be understood that not all aspects, advantages, and features described in this specification are necessarily achieved by or included in any particular embodiment. Indeed, while various embodiments have been described and illustrated herein, it will be apparent that other embodiments may be modified in their configuration and details.

What is claimed is:

1. A solid electrolytic capacitor comprising:
a first solid electrolyte layer disposed between an anode electrode layer and a first cathode electrode layer;
a second solid electrolyte layer disposed between the anode electrode layer and a second cathode electrode layer;
a first side electrode in contact with a first side surface of the anode electrode layer;
a second side electrode in contact with a side surface of the first cathode electrode layer and a side surface of the second cathode electrode layer;
an insulating portion disposed between a second side surface of the anode electrode layer and the second side electrode, the insulating portion including a resin;
a first insulating layer disposed between the first cathode electrode layer and the insulating portion, and including a resin and a filler; and
a second insulating layer disposed between the second cathode electrode layer and the insulating portion, and including a resin and a filler,
wherein
a filler content C_{Z1} (mass %) of the first insulating layer,
a filler content C_{Z2} (mass %) of the second insulating layer, and
a filler content C_{M0} (mass %) of the insulating portion
satisfy C_{M0}<C_{Z1} and C_{M0}<C_{Z2}.

2. A solid electrolytic capacitor comprising:
a first solid electrolyte layer disposed between an anode electrode layer and a first cathode electrode layer;
a second solid electrolyte layer disposed between the anode electrode layer and a second cathode electrode layer;
a first side electrode in contact with a first side surface of the anode electrode layer;
a second side electrode in contact with a side surface of the first cathode electrode layer and a side surface of the second cathode electrode layer;
an insulating portion disposed between a second side surface of the anode electrode layer and the second side electrode, and including a resin;
a first insulating layer disposed between the first cathode electrode layer and the insulating portion, and including a resin and a filler; and
a second insulating layer disposed between the second cathode electrode layer and the insulating portion, and including a resin and a filler,
wherein the insulating portion comprises:
a first resin layer located on a side of the first insulating layer;
a second resin layer located on a side of the second insulating layer; and
an intermediate resin layer disposed between the first resin layer and the second resin layer, and having a filler content higher than that of each of the first resin layer and the second resin layer, and
wherein
a filler content C_{Z1} (mass %) of the first insulating layer,
a filler content C_{Z2} (mass %) of the second insulating layer,
a filler content C_{M1} (mass %) of the first resin layer,
a filler content C_{M2} (mass %) of the second resin layer, and
a filler content C_{A1} (mass %) of the intermediate resin layer
satisfy C_{M1}<C_{Z1}, C_{M2}<C_{Z2}, C_{M1}<C_{A1}, and C_{M2}<C_{A1}.

3. The solid electrolytic capacitor according to claim 2, wherein C_{Z1}≤C_{A1} and C_{Z2}≤C_{A1} are satisfied.

4. The solid electrolytic capacitor according to claim 1, wherein the second side electrode comprises a plurality of stacked electrode layers.

5. The solid electrolytic capacitor according to claim 1,
wherein the second side electrode comprises:
a first electrode layer;
a second electrode layer; and
a third electrode layer,
the first electrode layer includes copper or silver, and is in contact with the first cathode electrode layer and the second cathode electrode layer;
the second electrode layer includes nickel, and is disposed between the first electrode layer and the third electrode layer, and
the third electrode layer comprises tin or gold.

6. The solid electrolytic capacitor according to claim 5, wherein the second electrode layer has a thickness of 1 μm or more and 5 μm or less.

7. The solid electrolytic capacitor according to claim 5, wherein
the first electrode layer has a thickness of 5 μm or more and 15 μm or less, and
the second electrode layer has a thickness of 1 μm or more and 5 μm or less.

8. The solid electrolytic capacitor according to claim 5, wherein
the first electrode layer has a thickness of 5 μm or more and 15 μm or less,
the second electrode layer has a thickness of 1 μm or more and 5 μm or less, and
the third electrode layer comprises tin and has a thickness of 3 μm or more and 7 μm or less.

9. The solid electrolytic capacitor according to claim 1, comprising a laminate including:
a plurality of solid electrolytic capacitor elements; and
an intermediate layer interposed between the solid electrolytic capacitor elements, and including a glass cloth and a resin,
wherein each of the solid electrolytic capacitor elements has a structure including the anode electrode layer, the first cathode electrode layer, the first solid electrolyte layer, the second cathode electrode layer, the second solid electrolyte layer, the insulating portion, the first insulating layer, and the second insulating layer.

10. The solid electrolytic capacitor according to claim 1, further comprising an insulating region disposed between the anode electrode layer and the insulating portion, wherein the insulating region comprises a first metal and a first resin.

11. The solid electrolytic capacitor according to claim 10,
wherein
the first metal includes aluminum, and
the first resin includes a thermosetting resin.

12. The solid electrolytic capacitor according to claim 1, comprising a laminate including a plurality of stacked solid electrolytic capacitor elements,
wherein each of the solid electrolytic capacitor elements has a structure including the anode electrode layer, the first cathode electrode layer, the first solid electrolyte layer, the second cathode electrode layer, the second solid electrolyte layer, the insulating portion, the first insulating layer, and the second insulating layer; and
wherein the laminate includes:
a topmost layer including a glass cloth and a resin, and
a bottommost layer including a glass cloth and a resin.

13. The solid electrolytic capacitor according to claim 1,
wherein
the first cathode electrode layer includes copper, and has a thickness of 1 μm or more and 20 μm or less, and
the second cathode electrode layer includes copper, and has a thickness of 1 μm or more and 20 μm or less.

14. The solid electrolytic capacitor according to claim 1,
wherein
the first insulating layer includes a resin and a filler, and a filler content C_{Z1} of the first insulating layer is 50 mass % or more and 80 mass % or less, and
the second insulating layer includes a resin and a filler, and a filler content C_{Z2} of the second insulating layer is 50 mass % or more and 80 mass % or less.

15. The solid electrolytic capacitor according to claim 1,
wherein the insulating portion includes a resin and a filler, and a filler content C_{M0} of the insulating portion is 0 mass % or more and 30 mass % or less.

16. The solid electrolytic capacitor according to claim 2,
wherein a filler content C_{A1} of the intermediate resin layer is 30 mass % or more and 80 mass % or less.

17. The solid electrolytic capacitor according to claim 16,
wherein
a filler content C_{M1} of the first resin layer is 0 mass % or more and 10 mass % or less, and
a filler content C_{M2} of the second resin layer is 0 mass % or more and 10 mass % or less.

18. The solid electrolytic capacitor according to claim 1,
wherein an adhesion strength at an interface between the second side electrode and the insulating portion is smaller than an adhesion strength at an interface between the second side electrode and the first cathode electrode layer, or at an interface between the second side electrode and the second cathode electrode layer.

19. The solid electrolytic capacitor according to claim 2,
wherein an adhesion strength at an interface between the second side electrode and the intermediate resin layer is greater than an adhesion strength at an interface between the second side electrode and the first resin layer, or at an interface between the second side electrode and the second resin layer.
